(19) United States
(12) Patent Application Publication
(10) Pub. No.: US 2013/0124171 A1
(43) Pub. Date: May 16, 2013

(54) SYSTEMS AND METHODS FOR PREDICTING WELL PERFORMANCE

(71) Applicants: John F. Schuette, Houston, TX (US); Doug S. Kenaley, Houston, TX (US); Owen J. Hehmeyer, Houston, TX (US)

(72) Inventors: John F. Schuette, Houston, TX (US); Doug S. Kenaley, Houston, TX (US); Owen J. Hehmeyer, Houston, TX (US)

(21) Appl. No.: 13/810,862

(22) PCT Filed: Jun. 3, 2011
(86) PCT No.: PCT/US11/39151

§ 371 Date: Jan. 17, 2013

Related U.S. Application Data
(60) Provisional application No. 61/369,476, filed on Jul. 30, 2010.

(51) Int. Cl. G06F 17/50; E21B 41/00

(52) U.S. Cl. CPC G06F 17/5009; E21B 41/0092
USPC 703/2; 166/250.15

(57) ABSTRACT

There is provided a method for predicting behavior of a physical system. An exemplary method comprises identifying a set of input variables that have an impact on an output metric and identifying a subset of the set of input variables the subset having a relatively larger impact on the output metric. A physical property model is built to predict the output metric as a function of the subset of the set of input variables. Postulated changes in the subset of the set of input variables are probabilistically ranked using the physical property model. Behavior of the physical system is predicted based on the rank of the postulated changes.

### CROSS-REFERENCE TO RELATED APPLICATION

This application claims the priority benefit of U.S. Provisional Patent Application 61/369,476 filed 30 July entitled Systems and Methods for Predicting Well Performance, the entirety of which is incorporated by reference herein.

### FIELD

The present techniques relate to a system and method for providing a physical property model representative of a physical property. In particular, an exemplary embodiment of the present techniques relates to employing a physical property model to predict well production performance and well stimulation response.

### BACKGROUND

This section is intended to introduce various aspects of the art, which may be associated with exemplary embodiments of the present invention. This discussion is believed to assist in providing a framework to facilitate a better understanding of particular aspects of the present invention. Accordingly, it should be understood that this section should be read in this light, and not necessarily as admissions of prior art.

Many applications involve processing information about physical properties. When processing information relating to physical properties of complex systems, it may be desirable to provide a physical property model representative of physical properties that are useful for a specific purpose. In the field of hydrocarbon exploration, physical property models may be used to predict the performance of a well or reservoir under a range of input conditions. Moreover, modeling well or reservoir performance may help hydrocarbon exploration professionals to improve production of hydrocarbon resources.

Oil and natural gas reservoirs are geologically heterogeneous, with some portions of a reservoir possessing physical properties conducive to oil and gas production, such as high permeability to flow and high oil saturation, and other portions of the same reservoir possessing physical properties detrimental to oil and gas flow, such as low permeability to flow and low oil saturation. The physical properties of reservoirs vary with depth and surface location, and may differ considerably over a variety of length scales. The heterogeneous nature of reservoirs leads to wide variation in the hydrocarbon productivity of wells in the same reservoir. The uncertainty of the hydrocarbon productivity of a proposed well must be minimized if decision-makers are to make accurate, timely, and profitable decisions regarding the drilling and placement of new wells.

As field development of the reservoir continues, the uncertainty about the physical properties of the reservoir are diminished, but complete knowledge is never obtained. Similarly, the hydrocarbon productivity response of an existing well to formation stimulation via fracturing or injection processes depends upon the uncertain reservoir properties.

Petroleum and natural gas reservoir engineers must make wellbore placement and stimulation decisions in the face of uncertainty about the nature of the reservoir pierced by the well, and consequently the hydrocarbon productivity of a well. Reduction of this uncertainty may lead to increased hydrocarbon production, fewer dry holes, improved stimulation practices, and fewer unnecessary field operations.

Decisions regarding the placement of new wells and the stimulation of existing wells rely in large part on data collected from wells drilled previously in the same or geologically similar reservoirs. Using this data, mathematical representations of physical property models of the reservoir are developed and used to predict the productivity of proposed wells.

The most basic mathematical representations of physical property models of reservoirs are called tank models and rely on the principle of mass balance alone. These models have severe limitations and have largely been supplanted by more sophisticated models which require computer simulation. Building a reservoir simulation model is enormously time-consuming, and the simulations themselves can take days or even weeks. These time limitations severely restrict the engineer's ability to do predictive modeling work for the wide variety of potential well placement or well stimulation scenarios. Even when the modeling is done in a timely manner, due to the uniqueness of each reservoir and the difficulty of making the measurements required by the mathematical models, these models often fail to provide adequate performance prediction.

U.S. Patent Application Publication No. 2006/0092766 describes a method for predicting production of a well. Log profiles for wells in a reservoir are associated with production indicators for wells in the reservoir. A log for the well is matched to a corresponding log profile. The log profiles may each be generated by clustering logs for wells in the reservoir. The log profiles and logs may include magnetic resonance imaging (MRI) and/or other suitable data.

U.S. Pat. No. 6,957,146 describes a method of geophysical exploration of a subsurface region of interest. The disclosed method uses an unsupervised learning network to organize seismic data representing a subsurface region of interest. A portion of the organized seismic data is correlated with lithological data from a well bore located in the subsurface region of interest and the correlation is applied to the seismic data to estimate lithology in the subsurface region of interest.

U.S. Patent Application Publication No. 2004/0133531 describes a system and method for selecting a training data set from a set of multidimensional geophysical input data samples for training a model to predict target data. The input data may be data sets produced by a pulsed neutron logging tool at multiple depth points in a cased well. Target data may be responses of an open hole logging tool. The input data is divided into clusters. Actual target data from the training well is linked to the clusters. The linked clusters are analyzed for variance, etc. and fuzzy inference is used to select a portion of each cluster to include in a training set. The reduced set is used to train a model, such as an artificial neural network (ANN). The trained model may then be used to produce synthetic open hole logs in response to inputs of cased hole log data.

International Patent Application Publication No. WO2006/112864 discloses a method and apparatus for modeling a system to estimate values and associated uncertainties for a first set of variables describing the system. A second set of system variables is selected, where the second set is directly or indirectly causally related to the first set of variables. Data is obtained or estimated for each variable in the second set and the quality of selected data is appraised. A network is formed with nodes including both sets of variables and the quality appraisals, having directional links connecting interdependent nodes, the directional links honoring known causality relationships. A Bayesian network (BN) algorithm is used with the data and quality information to solve the network for the first set of variables and their associated uncertainties.

Another known method of predicting well performance employs artificial intelligence-based methods after a well stimulation. One such approach uses geologic and well completion data such as well coordinates and the footage of perforated sand as inputs into an ANN-based model to predict the post-stimulation oil production rate.

Another approach relates to the use of a graphical unsupervised neural network such as a self organizing map (SOM) and ANNs to predict cumulative post fracture stimulation production from inputs such as proppant type and proppant mass. One such technique relates to an ANN to predict how wells will respond to treatment with polymers using inputs such as the oil and water rates before polymer treatment and the well coordinates. In another technique, inputs such as acid type, acid volume per perforation, and injection rate, among others, are fed into SOM and ANN-based models for the prediction of formation damage and post acid-stimulation production, respectively. Another technique employs SOMs for lithofacies identification and permeability prediction based on log data.

There are no generally applicable physical properties models for predicting whether or not a stimulation will be successful.

### SUMMARY

An exemplary embodiment of the present techniques comprises a method for predicting behavior of a physical system. An exemplary method comprises identifying a set of input variables that have an impact on an output metric and identifying a subset of the set of input variables the subset having a relatively larger impact on the output metric. A physical property model is built to predict the output metric as a function of the subset of the set of input variables. Postulated changes in the subset of the set of input variables are probabilistically ranked using the physical property model. Behavior of the physical system is predicted based on the rank of the postulated changes.)

The method of predicting behavior may comprise providing a visual representation of the physical property model. Identifying a subset of the set of input variables may comprise obtaining the subset of the set of input variables from a self organizing map.

Probabilistic ranking of postulated changes in the input variables may comprise obtaining outputs corresponding to postulated changes from a BN. A set of rules derived from probability estimates calculated using the BN may be provided. Alternatively, probabilistic ranking of postulated changes in the input variables may comprise obtaining outputs corresponding to postulated changes from a SOM.

In one exemplary embodiment of the present techniques, the physical system comprises at least one hydrocarbon-producing well. The output metric may comprise fluid productivity.

The set of input variables may comprise at least one of a depth, a location, core data, well log data, drilling data, completion data, stimulation data or well test data. In addition, the set of input variables may comprise at least one of a well design parameter, a drilling parameter, a completion design parameter or a stimulation design parameter. The set of input variables may comprise an interpretation of at least one of a geologic entity such as an interval, a horizon, a fracture, a fault or an environment. The set of input variables may also comprise an interpretation of a probability of occurrence of at least one of a geologic entity such as an interval, a horizon, a fracture, a fault or an environment.

An exemplary method according to the present techniques relates to producing hydrocarbons from an oil and/or gas field using a physical property model representative of a physical property of the oil and/or gas field. The method comprises identifying a set of input variables that have an impact on an output metric related to the oil and/or gas field and identifying a subset of the set of input variables. The subset is chosen because the input variables comprising the subset have a relatively larger impact on the output metric. A physical property model is built to predict the output metric related to the oil and/or gas field as a function of the subset of the set of input variables. Postulated changes in the subset of the set of input variables may be probabilistically ranked using the physical property model. The behavior of the oil and/or gas field may be predicted based on the rank of the postulated changes. Hydrocarbons are extracted from the oil and/or gas field based on the predicted behavior.

An exemplary method of extracting hydrocarbons may comprise providing a visual representation of the physical property model. Identifying a subset of the set of input variables may comprise obtaining the subset of the set of input variables from a SOM.

In one exemplary method of extracting hydrocarbons, probabilistically ranking postulated changes comprises obtaining outputs corresponding to postulated changes from a BN. A set of rules derived from probability estimates calculated using the BN may be provided.

In one exemplary embodiment, probabilistic ranking of postulated changes comprises obtaining outputs corresponding to postulated changes from a SOM. The output metric may comprise fluid productivity.

One exemplary embodiment of the present techniques relates to a computer system that is adapted to predict behavior of a physical system. The computer system comprises a processor and a tangible, machine-readable storage medium that stores machine-readable instructions for execution by the processor. The machine-readable instructions stored by the tangible, machine-readable storage medium may comprise code that, when executed by the processor, is adapted to cause the processor to identify a set of input variables that have an impact on an output metric. The machine-readable instructions may also comprise code that, when executed by the processor, is adapted to cause the processor to identify a subset of the set of input variables. The subset is chosen because it has a relatively larger impact on the output metric. The machine-readable instructions may additionally comprise code that, when executed by the processor, is adapted to cause the processor to build a physical property model to predict the output metric as a function of the subset of the set of input variables. The machine-readable instructions may further comprise code that, when executed by the processor, is adapted to cause the processor to probabilistically rank postulated changes in the subset of the set of input variables using the physical property model. In addition, the machine-readable instructions may comprise code that, when executed by the processor, is adapted to cause the processor to predict behavior of the physical system based on the rank of the postulated changes.

### DESCRIPTION OF THE DRAWINGS

Advantages of the present techniques may become apparent upon reviewing the following detailed description and drawings of non-limiting examples of embodiments in which:

FIG. 1 is a process flow diagram showing a data-driven process of predicting well performance according to an exemplary embodiment of the present techniques;

FIG. 2 is a process flow diagram showing a process of preparing to provide a probability calculator according to an exemplary embodiment of the present techniques;

FIG. 3 is a diagram showing a plurality of displays of a self-organizing map (SOM) that are useful in explaining the identification of highly influencing inputs according to an exemplary embodiment of the present techniques;

FIG. 4 is a Bayesian network representing a model in which three input variables are used to make a prediction according to an exemplary embodiment of the present techniques;

FIG. 5 is a node probability table describing the probabilistic relationship between var4 and var1 in the model of FIG. 4;

FIG. 6 is a Bayesian network representing a model in which three input variables are used to make a prediction according to an exemplary embodiment of the present techniques;

FIG. 7 is a Bayesian network representing a model in which three input variables are used to make a prediction according to an exemplary embodiment of the present techniques;

FIG. 8 is a Bayesian network representing a model in which three variables are used to make a prediction according to an exemplary embodiment of the present techniques;

FIG. 9 is a Bayesian network showing predictions for hydrocarbon production according to an exemplary embodiment of the present techniques;

FIG. 10 is a process flow diagram showing a method for predicting well performance in accordance with an exemplary embodiment of the present techniques;

FIG. 11 is a process flow diagram showing a method for producing hydrocarbons from a subsurface region such as an oil and/or gas field according to exemplary embodiments of the present techniques; and

FIG. 12 is a block diagram of a computer system that may be used to perform a method for predicting well performance according to exemplary embodiments of the present techniques.

While the present disclosure is susceptible to various modifications and alternative forms, specific example embodiments thereof have been shown in the drawings and are herein described in detail. It should be understood, however, that the description herein of specific example embodiments is not intended to limit the disclosure to the particular forms disclosed herein, but on the contrary, this disclosure is to cover all modifications and equivalents as defined by the appended claims. It should also be understood that the drawings are not necessarily to scale, emphasis instead being placed upon clearly illustrating principles of exemplary embodiments of the present invention. Moreover, certain dimensions may be exaggerated to help visually convey such principles.

### DETAILED DESCRIPTION

In the following detailed description section, the specific embodiments of the present invention are described in connection with preferred embodiments. However, to the extent that the following description is specific to a particular embodiment or a particular use of the present invention, this is intended to be for exemplary purposes only and simply provides a description of the exemplary embodiments. Accordingly, the invention is not limited to the specific embodiments described below, but rather, it includes all alternatives, modifications, and equivalents falling within the true spirit and scope of the appended claims.

At the outset, and for ease of reference, certain terms used in this application and their meanings as used in this context are set forth. To the extent a term used herein is not defined below, it should be given the broadest definition persons in the pertinent art have given that term as reflected in at least one printed publication or issued patent.

As used herein, the term “Bayesian network” refers to a probabilistic graphical model and its supporting calculations that represent a set of random variables and their conditional independencies.

As used herein, the term “computer component” refers to a computer-related entity, either hardware, firmware, software, a combination thereof, or software in execution. For example, a computer component can be, but is not limited to being, a process running on a processor, a processor, an object, an executable, a thread of execution, a program, and/or a computer. One or more computer components can reside within a process and/or thread of execution and a computer component can be localized on one computer and/or distributed between two or more computers.

As used herein, the terms “computer-readable medium”, “tangible machine-readable medium” or the like refer to any tangible storage that participates in providing instructions to a processor for execution. Such a medium may take many forms, including but not limited to, non-volatile media, and volatile media. Non-volatile media includes, for example, NVRAM, or magnetic or optical disks. Volatile media includes dynamic memory, such as main memory. Computer-readable media may include, for example, a floppy disk, a flexible disk, hard disk, magnetic tape, or any other magnetic medium, magneto-optical medium, a CD-ROM, any other optical medium, a RAM, a PROM, and EPROM, a FLASH-EPROM, a solid state medium like a holographic memory, a memory card, or any other memory chip or cartridge, or any other physical medium from which a computer can read. When the computer-readable media is configured as a database, it is to be understood that the database may be any type of database, such as relational, hierarchical, object-oriented, and/or the like. Accordingly, exemplary embodiments of the present techniques may be considered to include a tangible storage medium or tangible distribution medium and prior art-recognized equivalents and successor media, in which the software implementations embodying the present techniques are stored.

As used herein, the term “data driven” refers to an approach where predictions are made on a statistical basis (calibrated to data) as opposed to an approach where predictions are made on some first-principles basis (model-driven).

As used herein, the term “horizon” refers to mechanically marked boundaries in the subsurface structures that are deemed important by an interpreter. Marking these boundaries can be done by interpreters when they interpret seismic volumes by drawing lines on a seismic section. Each line represents the presence of an interpreted surface at that location. An interpretation project typically generates several dozen and sometimes hundreds of horizons. Alternatively, these boundaries can be marked by interpreters when they interpret well logs by marking interfaces between intervals of different lithologic or other character.

As used herein, the term “offset analysis” refers to the process of using nearby well performance to make predictions about the performance of a new well. This analysis may take into account the known properties of the subsurface at the nearby well and estimates of how those properties may differ at the location of the new well.

As used herein, the term “property” refers to a characteristic associated with different topological elements on a per element basis.

As used herein, the term “seismic data” refers to information collected by creating seismic waves with sources of seismic energy and observing the arrival times and amplitudes of the waves reflected from interfaces with contrasting acoustic velocity and/or bulk density or refracted through high-velocity intervals. These data are processed using procedures such as filtering, removing of multiples, muting, stacking, and migration.

As used herein, the term “self organizing map” refers to a type of artificial neural network that may be trained using unsupervised learning to produce a low-dimensional, discretized representation of an input space of data samples.

Some portions of the detailed description which follows are presented in terms of procedures, steps, logic blocks, processing and other symbolic representations of operations on data bits within a computer memory. These descriptions and representations are the means used by those skilled in the data processing arts to most effectively convey the substance of their work to others skilled in the art. In the present application, a procedure, step, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present application, discussions using the terms such as “adjusting”, “building”, “comparing”, “computing”, “creating”, “defining”, “determining”, “displaying”, “extracting”, “identifying”, “limiting”, “obtaining”, “performing”, “predicting”, “processing”, “producing”, “providing”, “ranking”, “selecting”, “storing”, “transforming”, “updating” or the like, refer to the action and processes of a computer system, or similar electronic computing device, that transforms data represented as physical (electronic) quantities within the computer system's registers and memories into other data similarly represented as physical quantities within the computer system memories or registers or other such information storage, transmission or display devices. Example methods may be better appreciated with reference to flow diagrams.

While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be required to implement an example methodology. Blocks may be combined or separated into multiple components. Furthermore, additional and/or alternative methodologies can employ additional, not illustrated blocks. While the figures illustrate various serially occurring actions, it is to be appreciated that various actions could occur concurrently, substantially in parallel, and/or at substantially different points in time.

In well production predictions, the uniqueness and complexity of reservoirs means that many factors may need to be considered to identify which of the factors impacts well performance in a particular reservoir. Furthermore, the natural variability of the subsurface and the unavailability of desired observations may facilitate a need for useful predictions that include an assessment of the uncertainty of that prediction. For example, a useful productivity prediction approach should help the engineer identify the most important performance factors for a particular field and also provide an assessment of the uncertainty of the predictions based on those factors.

According to exemplary embodiments of the present techniques, controllable stimulation factors that drive increased productivity may be identified by correlating a post-stimulation productivity measure, such as increased ultimate recovery, decreased skin, higher productivity index, etc., with stimulation, completion, and near-wellbore reservoir parameters. Rather than exhaustively exploring the parameter space, the use of a graphical unsupervised neural network such as a SOM may be used to guide the engineer to the important productivity parameters. Once constructed, the SOM can be used in a predictive mode. Stimulation factors, such as proppant type and volume, can be proposed and paired with the reservoir parameters. With this complete set of parameters, the SOM can then provide an estimate of the likely post-stimulation productivity.

A SOM according to exemplary embodiments of the present techniques may be used to build a physical property model to predict a desired output metric as a function of a subset of a larger set of input variables. The physical property model represents data corresponding to one or more properties of interest of a physical system such as a well or reservoir. As explained herein, the subset of input variables may be analyzed to probabilistically rank postulated changes to values of the subset of input variables using the physical property model.

Exemplary embodiments of the present techniques facilitate the integration of available data without the need for simplifying assumptions inherent in mathematically simplified physical models. In this manner, correlations between the available data and performance parameters can be found. Reservoir performance prediction problems, including estimating the productivity of proposed drill wells and estimating the response to stimulation treatment, may be solved with a data-driven approach, as outlined herein. Moreover, exemplary embodiments of the present techniques relate to a data-driven approach to hydrocarbon productivity prediction for new or existing wells.

According to an exemplary embodiment of the present techniques, a BN may be used to perform a process known as offset analysis to correlate geographic location, completion type, geologic data, well log data, and other static data with known production outcomes, such as oil rate and water cut. Moreover, an exemplary data-driven approach is well-suited for determining good geographic locations for new wells. Good locations for wells provide relatively high well productivity. An engineer can postulate new geographic locations, and use the BN to estimate the likely oil or water rate if the well is actually drilled.

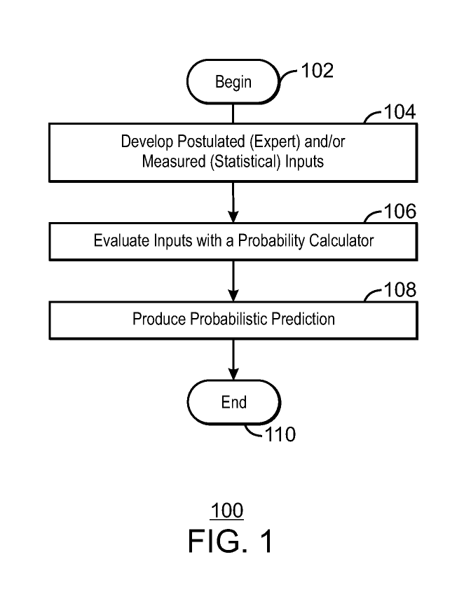

FIG. 1 is a process flow diagram showing a data-driven process of predicting well performance and/or productivity according to an exemplary embodiment of the present techniques. The diagram is generally referred to by the reference number 100. As fully set forth herein, the process 100 provides a performance prediction tool for physical systems. The general mathematical procedure for making a prediction according to the present techniques provides for the development of a mathematical model (i.e., a physical property model) that relates an output to some set of inputs. Given a new input, the model can then provide an estimate in the form of a new output.

At block 102, the exemplary process 100 begins. At block 104, a set of inputs is developed using various sources. For example, inputs may be postulated based on an expert's experience, or measured using statistical methods. For hydrocarbon production prediction, input data desirably exists for all wells of interest, if possible.

At block 106, the inputs that have been developed are evaluated with a probability calculator. A probability calculator according to an exemplary embodiment of the present techniques may be used to rank postulated changes in input variables in terms of the change they cause on a desired output metric. Such an algorithm according to an exemplary embodiment of the present techniques may facilitate recognition and identification of previous actions that lead to good or poor production. Moreover, as an exemplary algorithm reflects that knowledge, it may be used in a predictive capacity.

In one exemplary embodiment, a BN can be used to make predictions about an output metric of interest by ranking postulated changes in input conditions. In this case, the probabilistic relationships between the important input variables and the output variable(s) are captured in the BN, which may use them to make probabilistic predictions for the outcome given new observations of the input variables.

Bayes' theorem provides the mathematical foundation of a BN, an efficient mathematical framework for calculating probabilities according to Bayesian probability. The theorem is stated as:

P(A|B)=P(B|A)P(A)/P(B)

and may be read as the conditional probability of event A, given event B, is equal to the conditional probability of event B, given event A, times the prior probability of event A, normalized by the prior probability of event B.

Fundamentally, Bayes' theorem mathematically describes how to update beliefs about some event (A) based on new information (B). A BN is a computer-based implementation of Bayes' theorem that allows the calculation of the general case where there are many more variables involved. A typical BN includes a dozen or more variables and models the probabilistic relationships between them.

A BN employed in a data-driven productivity prediction according to the present techniques need not be a causally-constructed network. In such a case, the resulting network may be called a naïve BN. A naïve BN does not recreate the causal physical relationships between the variables. Instead, it assumes that all the model's input variables are a consequence of the predicted output variable. Despite its simple structure, this approach may produce effective predictions.

Moreover, a BN according to the present techniques is not limited to representing models that are based on physical causal relationships between geologic and engineering factors. As explained herein, a naïve BN, whose structure can be determined automatically based on the available data, may be used to make predictions. According to an exemplary embodiment, an effective BN can be built even before an expert understands the key factors that determine the reservoir's performance. This approach may simplify the construction of the prediction model.

Once built, that BN can be examined to help decide which factors are key in evaluating well productivity. The resulting model is a statistical model of the reservoir's behavior. The statistical model does not necessarily offer any insight into how the key physical factors behind the data interact to produce the observed response. Using a BN as the prediction framework, however, preserves the option to evolve the model into a causal, more physically-based model as experts increase their understanding of the physical behavior of the reservoir.

Alternatively, a probability calculator according to the present techniques may employ a SOM. Moreover, a SOM can be used to make predictions about how changes to inputs affect an output metric. Predictions may be made by determining into which cluster new observations fall and assuming that the outcomes for those new observations will be similar to those for previous observations in that cluster.

Continuing with the flow of the process 100, a probabilistic prediction is provided, as shown at block 108. The probabilistic prediction is based on the output of the probability calculator, as explained herein. The probabilistic prediction may be used to evaluate the performance of one or more wells. This data driven approach differs from previous predictive methods because no physical model is needed. In addition, the statistical information associated with model construction using a physical model is also not needed according to the present techniques.

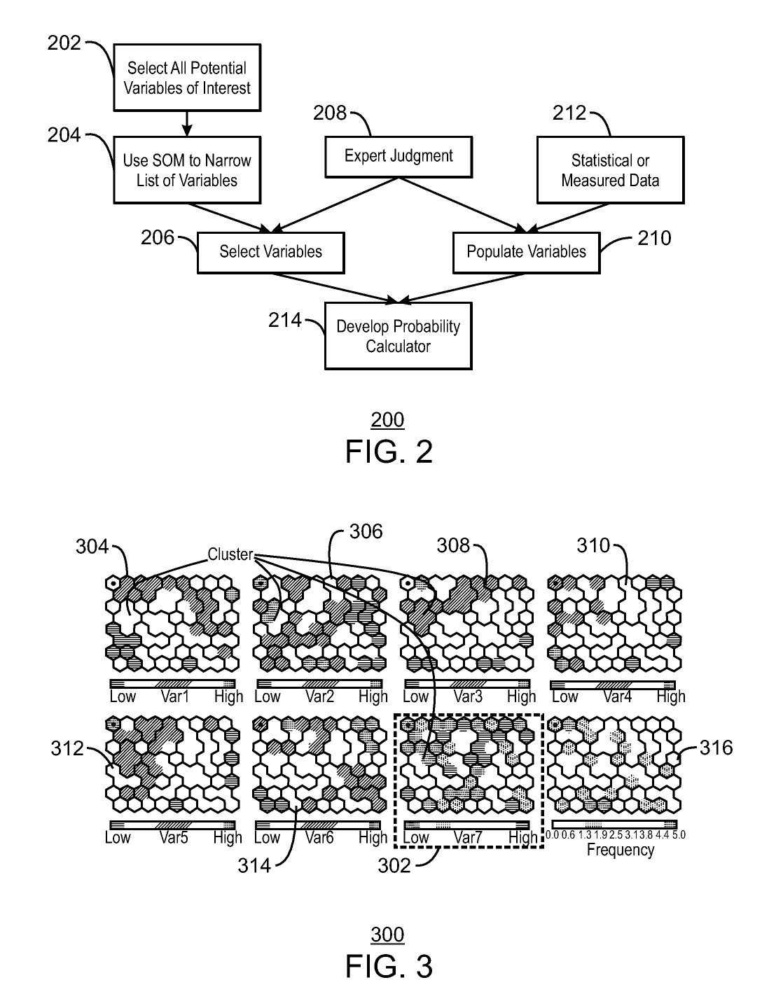

FIG. 2 is a process flow diagram showing a process of preparing to provide a probability calculator according to an exemplary embodiment of the present techniques. The process is generally represented by the reference number 200.

At block 202, a set of all potential variables of interest are selected. In an exemplary method of predicting hydrocarbon production, any variable that is believed to have an impact on production should be included in the initial set. In creating the initial set of variables, historical data for wells of interest are gathered. The historical data is desirably representative of the full range of behaviors exhibited by the wells. Examples of variables that may be important include temperature, production rate, pressure, depth to sand, well location, and length of perforation from a collection of hypothesized variables that spans the range of geological, completion, production, and stimulation variable types.

It may be computationally infeasible to take into account the effects of all known variables when predicting an output metric of interest. Accordingly, reducing the number of inputs to consider may be desirable.

At block 204, a SOM is used to identify a subset of inputs having the biggest impact on a desired output metric such as hydrocarbon production. A SOM is a type of unsupervised neural network, which may employ artificial intelligence methods. SOMs group a large number of chosen data objects (e.g., wells) according to their total similarity across multiple attributes (static or pseudo-static parameters). SOMs have successfully been applied for candidate recognition, permeability predictions, optimization of fracture inputs, and delineating lithofacies systems. Examples of SOMs are discussed below with reference to FIG. 3.

At block 206, a subset of the initial set of variables identified by the SOM is selected. According to an exemplary embodiment of the present techniques, the subset of variables is chosen because the inputs that comprise the subset are believed to have the most significant impact on predicting an output metric related to performance or behavior of a physical system such as a well or reservoir. By identifying the input variables having the most significant impact on the behavior of a system, subsequent prediction steps may be less costly in terms of computing resources relative to prediction using the entire range of inputs from which the subset is selected.

As shown at block 208, expert judgment may be applied when determining whether all variables identified by the SOM should be used for subsequent predictive analysis. Moreover, an expert may be able to interpret the results provided by the SOM to include or exclude inputs from being used in the subsequent predictive analysis. At block 210, the variables representative of the inputs believed to have the most impact for predictive purposes are populated with actual data. The data may comprise statistical or measured data, as indicated by block 212. Using the selected subset of variables (block 206) populated with data (block 210), a probability calculator is developed, as shown at block 214. Those of ordinary skill in the art will appreciate that any mathematically-related algorithm that computes joint probabilities, such as Bayes' theorem, may be used to provide the probability calculator.

Thus developed, the physical property model may be used as predictive tool by presenting postulated and/or measured sets of input data to the probability calculator and observing output. A probability calculator according to the present techniques may desirably be refined over time. By presenting the probability calculator with input data sets for which the outputs are known, the accuracy of the probability calculator may be assessed.

Exemplary embodiments of the present techniques may be employed to analyze a wide range of predictive inquiries. One example of a query that may be analyzed is the five-year recovery of a treatment given a stimulation on a specific well using a specific fluid volume. A predictive model according to the present techniques would desirably provide an informed prediction for this question taking into account the multivariable history of stimulation in the entire field.

FIG. 3 is a diagram showing a plurality of displays of an SOM that are useful in explaining the identification of highly influencing inputs according to an exemplary embodiment of the present techniques. The diagram is generally referred to by the reference number 300. As explained herein, a SOM may be used to identify important variables most likely to have an impact on a desired output variable.

The diagram shows a SOM for each of seven variables and an eighth SOM representative of a frequency. The varying types of cross-hatching shown in FIG. 3 represent a calculated typical magnitude for data records grouped together in clusters. The clusters shown in the SOMs of FIG. 3 represent data values within a defined range. In an exemplary embodiment, the variables shown in the diagram 300 may be relevant to evaluating hydrocarbon production.

In the diagram 300, an output variable var7 302 is a normalized measure of formation damage. The different types of cross-hatching depicted in the output variable var7 302 are representative of varying degrees of reservoir damage. The input variables shown in the diagram 300 are footage of perforated sand (var1 304), a pressure measurement (var2 306), a rate measurement (var3 308), a rate per permeability thickness (var4 310), a near-wellbore fluid velocity (var5 312), and a perforated permeability thickness (var6 314). In an exemplary embodiment, all of the input variables shown in the diagram 300 are weighted equally. A SOM could include fewer or larger numbers of input variables, and the variables may have different weights. For the variables shown in FIG. 3, a SOM with more than 20 variables was initially used to sift through variables.

In the diagram 300, several clusters of data (groups of adjacent cells) are identified by black outlines. An example interpretation of the meaning of one cluster of output nodes is as follows. All of the nodes populating the cluster indicated in the output variable map are given an initial color or shade, indicative of a uniformly low hydrocarbon productivity. The topologically identical cluster (i.e., the cluster in the same relative position) in the input variable maps show a uniformly low value of perforated sand (var1 304), high pressure measurement (var2 306), and medium rate value (var3 308). Therefore, this combination of variables is likely detrimental to well productivity. When interpreting the output variable (var7 302) it is desirable to consult a frequency map 316, which shows how many wells have been assigned to that map node and cluster. The indicated cluster is well-populated, as at least one well is assigned to every node. After key variables have been identified by a SOM, they are included in a predictive model, as described herein.

A SOM with few distinct clusters is less indicative of variables that have a significant impact on an output metric of interest. High levels of data density and an inclusive list of variables should produce mathematically distinct clusters. Thus, a SOM according to an exemplary embodiment of the present techniques is desirably “data dense,” meaning that all of the nodes on the SOM are densely populated with data. Moreover, data for ten or more wells per map node may be desirable. In addition, it is desirable for data to exist for all of the nodes. Missing data affects the ability of the SOM to classify those nodes into clusters.

If the SOM has a difficult time producing distinct clusters, a reduction in the candidate variable list may aide the process by reducing the number of degrees of freedom. Through a trial and error process of building initially large SOMs and then reducing the number of variable maps gradually by eliminating the variables showing the least correlation, increasingly mathematically distinct clusters may be identified. Also, the user may experiment with different variable weights. The specific variables and variable weights may be chosen based on the specific parameters of a particular well productivity problem. An exemplary SOM software toolkit may include tools that automatically test many combinations of variables and quantitatively measure the mathematical distinctness of clusters of wells.

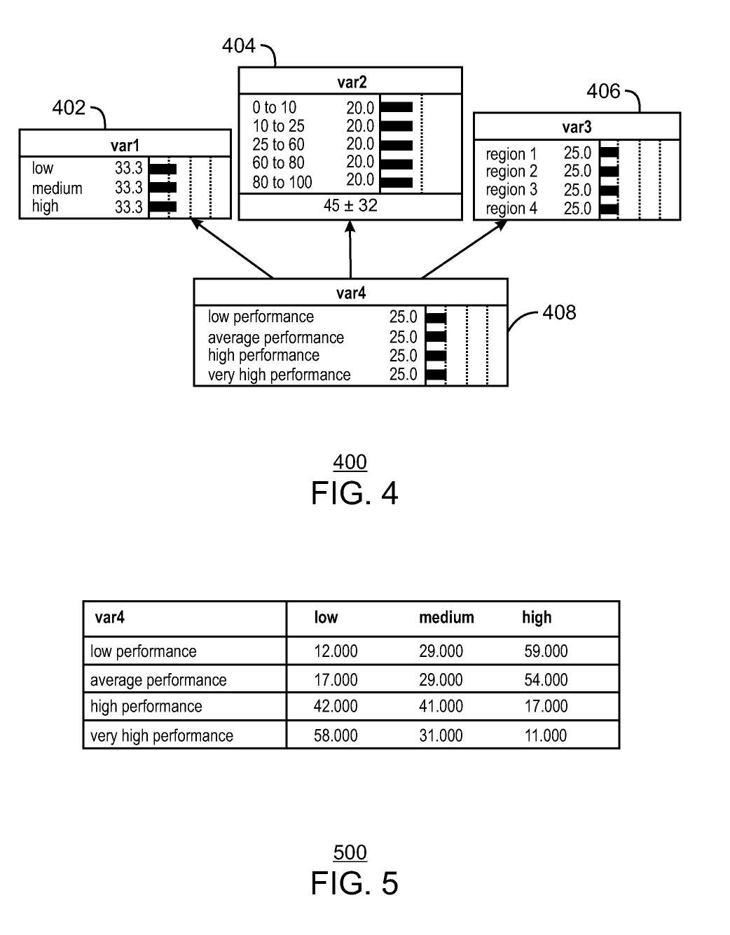

FIG. 4 is a Bayesian network showing the use of three input variables to make a prediction according to an exemplary embodiment of the present techniques. The network is generally referred to by the reference number 400. The BN 400 may be used as a probability calculator according to the present techniques. In the BN 400, three input variables have been identified by a SOM to be predictive of an output variable. Namely, a first input variable var1 402, a second input variable var2 404 and a third input variable 406, have a predictive impact on a first output variable var4 408.

FIG. 5 is a node probability table describing the probabilistic relationship between var4 and var1 in the model of FIG. 4. Historical data may be used to calibrate this relationship according to an exemplary embodiment of the present techniques. The table is generally referred to by the reference number 500. The values in the table represent estimates of conditional probabilities for the input variable var1 402 (FIG. 4), conditioned on the output variable var4 408 and may be obtained by the analysis of historical data or from expert judgment.

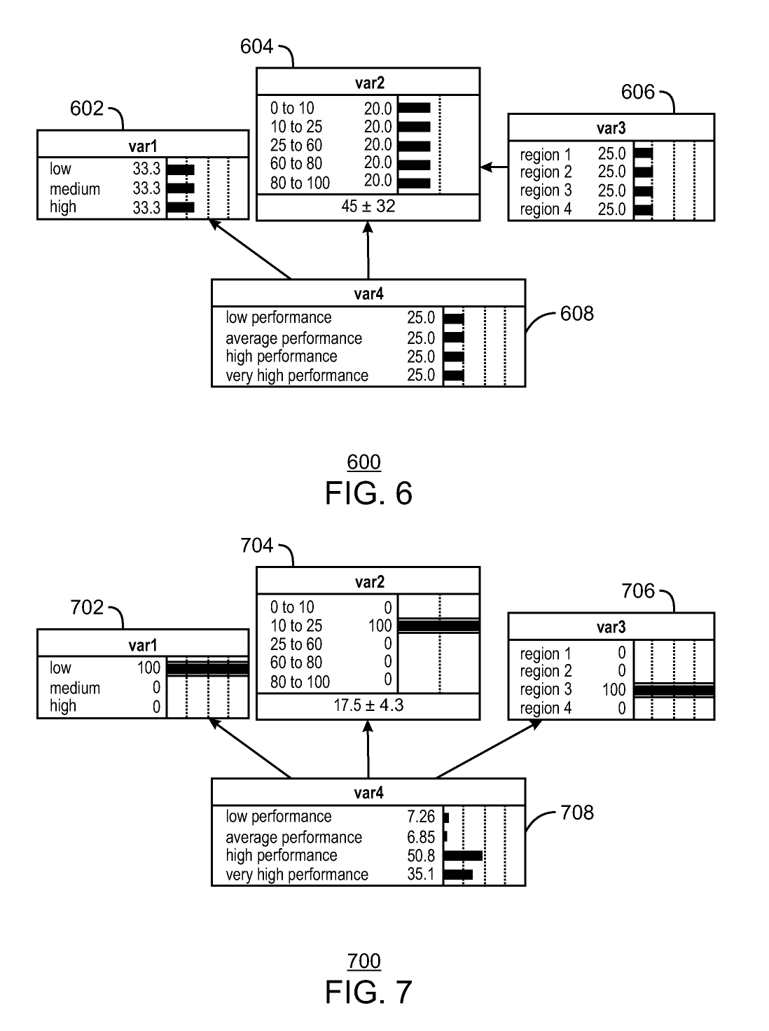

FIG. 6 is a Bayesian network showing the use of three input variables to make a prediction according to an exemplary embodiment of the present techniques. The network is generally referred to by the reference number 600. In the BN 600, three input variables have been identified by a SOM to be predictive of an output variable. Namely, a first input variable var1 602, a second input variable var2 604 and a third input variable 606, have a predictive impact on a first output variable var4 608.

The BN 600 differs from the BN 400 (FIG. 4) in that the probability table 600 reflects a belief that the primary influence of the third input variable var3 606 is that it controls the second input variable var2 604. Moreover, the third input variable var3 606 is not shown to have a direct impact on the first output variable var4 608.

In one exemplary embodiment, the structure of a BN, as represented by a probability table, may be modified or built based on expert judgment. Moreover, an exemplary BN may be designed to reflect relationships the expert believes to exist in nature. For example, the structure of a BN may be based on an assumption that a primary influence of the third input variable var3 606 is that it controls the second input variable var2 604.

In a BN represented by the probability table 600, the third input variable var3 606 may still influence the first output variable var4 608, but it does so through its influence on the second input variable var2 604. According to an exemplary embodiment, populating the conditional probability tables may be done either by estimating the probabilities from the historical data or by asking the experts themselves to estimate the probabilities. Some integration of the two methods is possible, as well.

One of the advantages of using expert judgment to guide construction of the predictive BN is that the expert judgment can be used to “adjust” the model for cases for which future situations are expected to be different from that historical data. Conversely, one of the risks of an expert-based network is that biases will be included in the network and affect its performance.

As explained herein, one exemplary embodiment of the present techniques relates to the application of a predictive model. Once a predictive BN is built, it may be used by specifying values for the available inputs (for example, input variables var1, var2, var3 in the above example) and noting the prediction for an output variable such as the output variable var4. This can be done manually by a user of the BN software or can be done in batch mode by the BN software or other software that has BN calculation features.

FIG. 7 is a Bayesian network representing a model in which three input variables are used to make a prediction according to an exemplary embodiment of the present techniques. The BN is generally referred to by the reference number 700. In the BN 700, three input variables have been identified to be predictive of an output variable. Namely, a first input variable var1 702, a second input variable var2 704 and a third input variable 706, have a predictive impact on a first output variable var4 708.

One of the advantages of using a BN in the predictive role is that the BN 700, gives an estimate of the uncertainty of the prediction. Consider the case in which the first input variable var1 702 has a value of low, the second input variable var2 704 has a value of between 10 and 25 and the third input variable var3 706 has a value of region 3. As shown in the BN 700, there is a greater than 85% chance that a well with those characteristics will be at least a high performer. This probability is obtained by summing the probability for high performance (50.8%) and the probability for very high performance (35.1%).

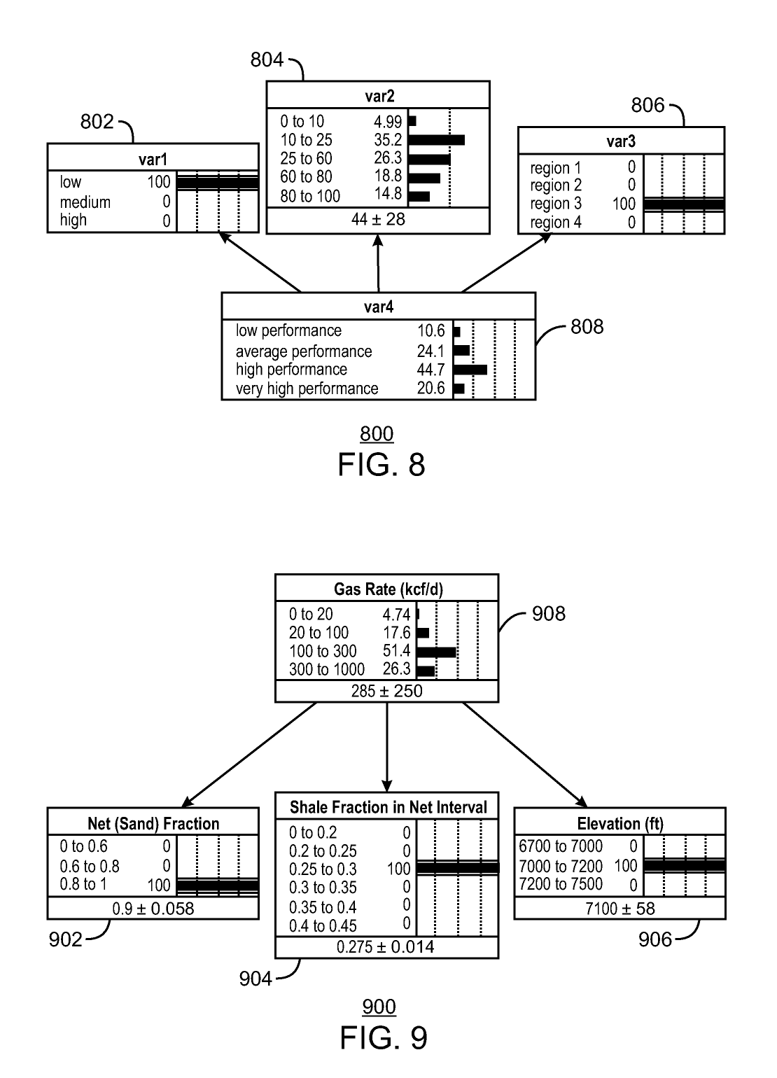

FIG. 8 is a BN representing a model in which three variables are used to make a prediction according to an exemplary embodiment of the present techniques. The BN is generally referred to by the reference number 800. In the BN 800, three input variables have been identified to be predictive of an output variable. Namely, a first input variable var1 802, a second input variable var2 804 and a third input variable 806, have a predictive impact on a first output variable var4 808.

Another advantage of using the BN for prediction is that prediction is still possible when values for one or more (or all) variables are not available. The BN 800 gives predictions for the case where a specific value for var2 is not available. It may be assumed that the value of var2 is unspecified because its value is still displayed as a probability distribution (the distribution consistent with the inputs that are available). Although it is possible that the displayed probability distribution could have been provided as input, it is unlikely. Note that the first output variable var4 808 behaves as expected in that its value is less certain (the distribution is broader than that of var4 708).

FIG. 9 is a Bayesian network showing predictions for hydrocarbon production according to an exemplary embodiment of the present techniques. The BN is generally referred to by the reference number 900. In the BN 900, three input variables have been identified to be predictive of an output variable. Namely, a net (sand) fraction input variable 902, a shale fraction input variable 904 and an elevation input variable 906, have a predictive impact on a gas rate output variable 908.

The objective of BN 900 is to predict gas flow rate from a particular interval in a newly drilled well. Corresponding to each of the input nodes 902, 904 and 906 is a conditional probability table that describes the statistical relationship between the gas rate output variable 908 and each of the input variables. The gas rate variable 908 also describes the probability of different gas rates. All of the probabilistic information shown in BN 900 is estimated from the historical data.

The BN 900 shows the prediction for a particular set of inputs. In particular, the gas rate output variable 908 shows that there is a greater than 75% chance the well will flow more than 100 kcsf/d.

In an exemplary embodiment, the BN 900 represents a BN that has been built using the naïve Bayes approach. The input variables were selected based on evidence that there is some statistical relationship between them and the gas rate output variable 908. Another approach to building a BN is based on a causal understanding of the combined geologic and engineering system. In such a network, it is noted with interest that elevation would play a part as a predictive input variable. A physically-based consideration of the system may suggest a different variable for which elevation is merely the best available proxy in the current database.

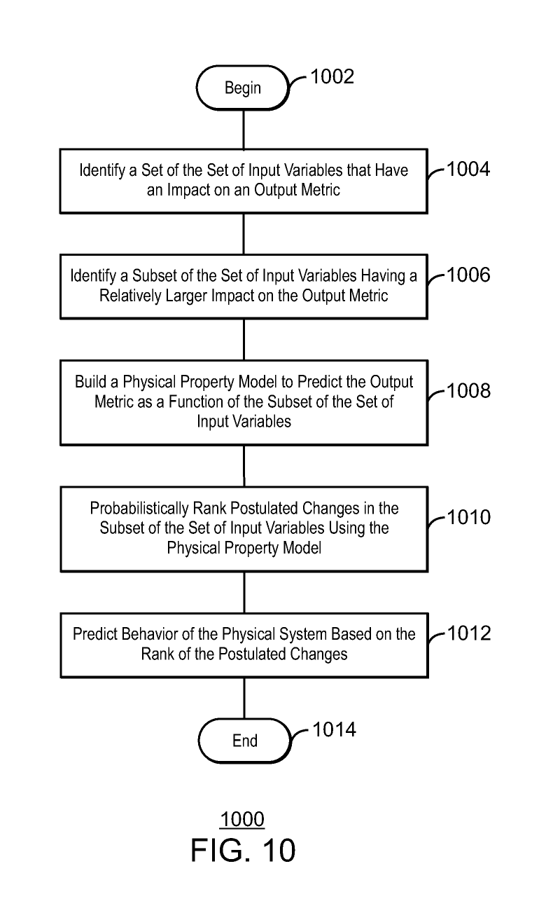

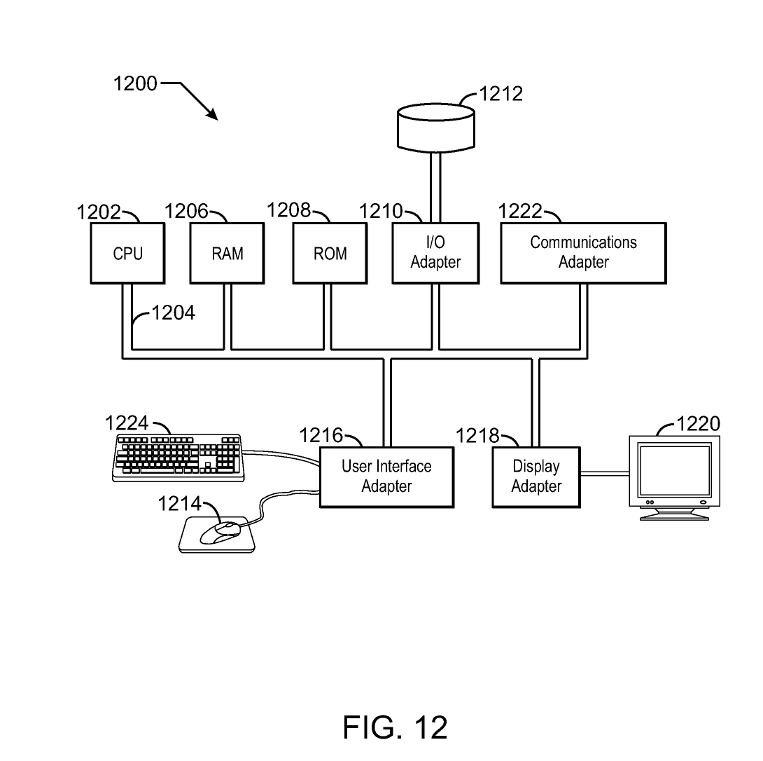

FIG. 10 is a process flow diagram showing a method for predicting behavior of a physical system in accordance with an exemplary embodiment of the present techniques. The process is generally referred to by the reference number 1000. The process 1000 may be executed using one or more computer components of the type described herein with reference to FIG. 12. Such computer components may comprise one or more tangible, machine-readable media that stores computer-executable instructions. The process 1000 begins at block 1002.

At block 1004, a set of input variables that have an impact on an output metric is identified. A subset of the set of input variables having a relatively larger impact on the output metric is identified, as indicated at block 1006.

As shown at block 1008, a physical property model is built to predict the output metric as a function of the subset of the set of input variables. Postulated changes in the subset of the set of input variables are probabilistically ranked using the physical property model, as shown at block 1010. At block 1012, behavior of the physical system is predicted based on the rank of the postulated changes. The process 1000 ends, as shown at block 1014.

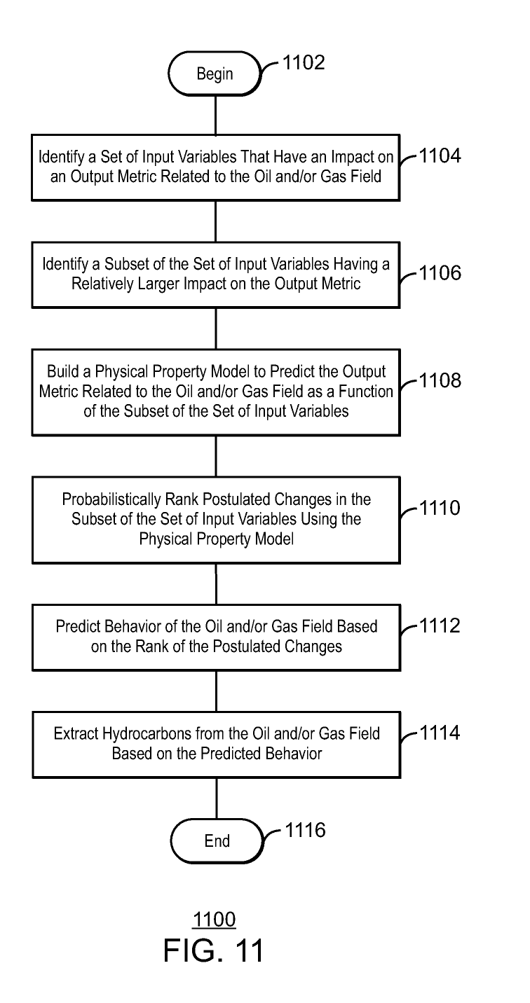

FIG. 11 is a process flow diagram showing a method for producing hydrocarbons from a subsurface region such as an oil and/or gas field according to exemplary embodiments of the present techniques. The process is generally referred to by the reference number 1100. According to an exemplary embodiment of the present techniques, hydrocarbon production is facilitated through the prediction of well performance in accordance with an exemplary embodiment of the present techniques.

Those of ordinary skill in the art will appreciate that the present techniques may facilitate the production of hydrocarbons by producing visualizations that allow geologists, engineers and the like to determine a course of action to take to enhance hydrocarbon production from a subsurface region. By way of example, a visualization produced according to an exemplary embodiment of the present techniques may allow an engineer or geologist to determine a well placement to increase production of hydrocarbons from a subsurface region. At block 1102, the process begins.

At block 1104, a set of input variables that have an impact on an output metric related to the oil and/or gas field is identified. A subset of the set of input variables having a relatively larger impact on the output metric is identified, as shown at block 1106.

At block 1108, a physical property model is built to predict the output metric related to the oil and/or gas field as a function of the subset of the set of input variables. Postulated changes in the subset of the set of input variables are probabilistically ranked using the physical property model, as shown at block 1110. At block 1112, behavior of the oil and/or gas field is predicted based on the rank of the postulated changes. Hydrocarbons are extracted from the oil and/or gas field based on the predicted behavior, as shown at block 1114. The process ends, as shown at block 1116.

FIG. 12 is a block diagram of a computer system that may be used to perform a method for predicting behavior of a physical system according to exemplary embodiments of the present techniques. The computer network is generally referred to by the reference number 1200.

A central processing unit (CPU) 1202 is coupled to system bus 1204. The CPU 1202 may be any general-purpose CPU, although other types of architectures of CPU 1202 (or other components of exemplary system 1200) may be used as long as CPU 1202 (and other components of system 1200) supports the inventive operations as described herein. The CPU 1202 may execute the various logical instructions according to various exemplary embodiments. For example, the CPU 1202 may execute machine-level instructions for performing processing related to predicting the behavior of physical systems according to the operational flow described herein with reference to FIG. 10 and FIG. 11.

The computer system 1200 may also include computer components such as a random access memory (RAM) 1206, which may be SRAM, DRAM, SDRAM, or the like. The computer system 1200 may also include read-only memory (ROM) 1208, which may be PROM, EPROM, EEPROM, or the like. RAM 1206 and ROM 1208 hold user and system data and programs, as is known in the art. The computer system 1200 may also include an input/output (I/O) adapter 1210, a communications adapter 1222, a user interface adapter 1216, and a display adapter 1218. The I/O adapter 1210, the user interface adapter 1216, and/or communications adapter 1222 may, in certain embodiments, enable a user to interact with computer system 1200 in order to input information.

The I/O adapter 1210 preferably connects a storage device(s) 1212, such as one or more of hard drive, compact disc (CD) drive, floppy disk drive, tape drive, etc. to computer system 1200. The storage device(s) may be used when RAM 1206 is insufficient for the memory requirements associated with storing data for operations of embodiments of the present techniques. The data storage of the computer system 1200 may be used for storing information and/or other data used or generated as disclosed herein. The communications adapter 1222 may couple the computer system 1200 to a network (not shown), which may enable information to be input to and/or output from system 1200 via the network (for example, the Internet or other wide-area network, a local-area network, a public or private switched telephony network, a wireless network, any combination of the foregoing). The user interface adapter 1216 couples user input devices, such as a keyboard 1224, a pointing device 1214, and/or output devices, such as a speaker(s) (not shown) to the computer system 1200.

The display adapter 1218 is driven by the CPU 1202 to control the display on a display device 1220 to, for example, display information or a representation pertaining to a portion of a subsurface region under analysis, such as displaying a prediction about the behavior of a physical system, according to certain exemplary embodiments.

The architecture of system 1200 may be varied as desired. For example, any suitable processor-based device may be used, including without limitation personal computers, laptop computers, computer workstations, and multi-processor servers. Moreover, embodiments may be implemented on application specific integrated circuits (ASICs) or very large scale integrated (VLSI) circuits. In fact, persons of ordinary skill in the art may use any number of suitable structures capable of executing logical operations according to the embodiments.

Exemplary well production analyses according to the present techniques may employ potentially large volumes of historical data to help make reservoir management decisions. These analyses may be used to inform or guide specific reservoir management decisions that could have significant cost or performance implications.

The present techniques may be susceptible to various modifications and alternative forms, and the exemplary embodiments discussed above have been shown only by way of example. However, the present techniques are not intended to be limited to the particular embodiments disclosed herein. Indeed, the present techniques include all alternatives, modifications, and equivalents falling within the spirit and scope of the appended claims.

What is claimed is:

1. A method for predicting behavior of a physical system, comprising:
identifying a set of input variables that have an impact on an output metric;
identifying a subset of the set of input variables, the subset having a relatively larger impact on the output metric;
building a physical property model to predict the output metric as a function of the subset of the set of input variables;
probabilistically ranking postulated changes in the subset of the set of input variables using the physical property model; and
predicting behavior of the physical system based on the rank of the postulated changes.

2. The method recited in claim 1, comprising providing a visual representation of the physical property model.

3. The method recited in claim 1, wherein identifying a subset of the set of input variables comprises obtaining the subset of the set of input variables from a self organizing map (SOM).

4. The method recited in claim 1, wherein probabilistically ranking postulated changes comprises obtaining outputs corresponding to postulated changes from a Bayesian network (BN).

5. The method recited in claim 4, comprising providing a set of rules derived from probability estimates calculated using the BN.

6. The method recited in claim 1, wherein probabilistically ranking postulated changes comprises obtaining outputs corresponding to postulated changes from a self organizing map (SOM).

7. The method recited in claim 1, wherein the physical system comprises at least one hydrocarbon-producing well.

8. The method recited in claim 1, wherein the output metric comprises fluid productivity.

9. The method recited in claim 1, wherein the set of input variables comprises at least one of a depth, a location, core data, well log data, drilling data, completion data, stimulation data or well test data.

10. The method recited in claim 1, wherein the set of input variables comprises at least one of a well design parameter, a drilling parameter, a completion design parameter or a stimulation design parameter.

11. The method recited in claim 1, wherein the set of input variables comprises an interpretation of at least one of a geologic entity such as an interval, a horizon, a fracture, a fault or an environment.

12. The method recited in claim 1, wherein the set of input variables comprises an interpretation of a probability of occurrence of at least one of a geologic entity such as an interval, a horizon, a fracture, a fault or an environment.

13. A method for producing hydrocarbons from an oil and/or gas field using a physical property model representative of a physical property of the oil and/or gas field, the method comprising:
identifying a set of input variables that have an impact on an output metric related to the oil and/or gas field;
identifying a subset of the set of input variables, the subset having a relatively larger impact on the output metric;
building a physical property model to predict the output metric related to the oil and/or gas field as a function of the subset of the set of input variables;
probabilistically ranking postulated changes in the subset of the set of input variables using the physical property model;
predicting behavior of the oil and/or gas field based on the rank of the postulated changes; and
extracting hydrocarbons from the oil and/or gas field based on the predicted behavior.

14. The method recited in claim 13, comprising providing a visual representation of the physical property model.

15. The method recited in claim 13, wherein identifying a subset of the set of input variables comprises obtaining the subset of the set of input variables from a self organizing map (SOM).

16. The method recited in claim 13, wherein probabilistically ranking postulated changes comprises obtaining outputs corresponding to postulated changes from a Bayesian network (BN).

17. The method recited in claim 16, comprising providing a set of rules derived from probability estimates calculated using the BN.

18. The method recited in claim 13, wherein probabilistically ranking postulated changes comprises obtaining outputs corresponding to postulated changes from a self organizing map (SOM).

19. The method recited in claim 13, wherein the output metric comprises fluid productivity.

20. A computer system that is adapted to predict behavior of a physical system, the computer system comprising:
a processor; and
a tangible, machine-readable storage medium that stores machine-readable instructions for execution by the processor, the machine-readable instructions comprising:
code that, when executed by the processor, is adapted to cause the processor to identify a set of input variables that have an impact on an output metric;
code that, when executed by the processor, is adapted to cause the processor to identify a subset of the set of input variables, the subset having a relatively larger impact on the output metric;
code that, when executed by the processor, is adapted to cause the processor to build a physical property model to predict the output metric as a function of the subset of the set of input variables;
code that, when executed by the processor, is adapted to cause the processor to probabilistically ranking postulated changes in the subset of the set of input variables using the physical property model; and
code that, when executed by the processor, is adapted to cause the processor to predict behavior of the physical system based on the rank of the postulated changes.
